(19) United States
(12) Patent Application Publication
(10) Pub. No.: US 2012/0280168 A1
(43) Pub. Date: Nov. 8, 2012

(54) Silver-nanowire thermo-interface material composite

(75) Inventors: Chen-Chi Ma, Hsinchu City (TW); Ming-Hsiung Wei, Taoyuan County (TW); Yi-Hsiuan Yu, Taoyuan County (TW); Chih-Chun Teng, Taichung City (TW)

(73) Assignee: Chung-Shan Institute of Science and Technology, Armaments, Bureau, Ministry of National Defense, Taoyuan County (TW)

(21) Appl. No.: 13/099,561

(22) Filed: May 3, 2011

(51) Int. Cl. C09K 5/00; B82Y 30/00

(52) U.S. Cl. 252/75; 252/74; 977/762

(57) ABSTRACT

A thermo-interface material composite uses a thermo-interface material containing silver nanowires. The silver nanowires have high aspect ratios, high thermo-conductivity coefficients and good anti-oxidation capabilities. Hence, an amount of silver nanowires can be added fewer than that of a traditional metal or ceramic powder. In this way, defects on device surface can be speckled during a dispersal process for improving adhesion between devices. Thus, a thermo-interface material is fabricated to obtain a high thermo-conductivity coefficient for further forming a thermo-channel.

### TECHNICAL FIELD OF THE DISCLOSURE

The present disclosure relates to a thermo-interface material; more particularly, relates to providing a thermo-interface material having silver nanowires added in a polymer substrate for high thermo-conductivity.

### DESCRIPTION OF THE RELATED ARTS

Nowadays, electronic devices are fabricated with a trend toward small size, light weight and high density. But, since electronic devices will generate heat when running, their performance may become poor, signals they produce may have errors, or even, they may be damaged, if the heat cannot be effectively dissipated. Hence, when running a precise electronic device, heat dissipation capacity is a crucial factor to its life and characteristics.

For almost every thermo-interface material, a high content of a ceramic or metal powder having a high thermo-conductivity is added, including AlN, BN, Al2O3, SiC, Ag, etc. They all have good thermo-conductivity coefficients. But, non-organic material may have a specific weight too high for simple fabrication and so that mechanical strength of the thermo-interface material is reduced.

Ag (silver) has good heat conductivity and is not easily oxidized as comparing to copper. Hence, it is quite fit for making a thermo-interface material.

Regarding traditional thermo-interface material of silver particles, its thermo-conductivity coefficient is increased by increasing the content of thermo-conductive particles in a polymer substrate to make the particles contact with each other as intimately as possible. But, when the content is increased to a certain degree, adhesion of the polymer mixture is increased, fabrication becomes difficult and its original toughness is lost. Thereafter, metal nanowires (e.g. silver nanowire) are introduced for heat dissipation.

In the past, metal nanowires or silver nanowires were mainly found to be used for academic reports; and most of them use single silver nanowire for measurement and theoretical reduction. Their thermo-conductive effects were figured out without being interrupted by other mixture like Pt, Bi, Bi/Sb alloy, or Sn. Or, some may use few parallel nanowires for measuring thermo-conductivity value, whose dissipation effect is improved as well. Yet, if the nanowires were to be actually used for dissipation, they have to be mixed with a paste for obtaining a pasting material. A prior art uses silver nanowires and copper particles to be mixed into a silica paste to obtain a thermo-conductive paste for packaging light emitting diode (LED). The silver nanowires are sintered with the metal particles at a relatively low temperature, which can be downed to around 225° C., for improving dissipation effect. However, the rigidity and mechanical characteristics of the silica paste are not good; the temperature for sintering has reached the heat tolerance limit of the silica paste; and, copper may be easily oxidized. Hence, the prior arts do not fulfill all users' requests on actual use.

### SUMMARY OF THE DISCLOSURE

The main purpose of the present disclosure is to provide a thermo-interface material having silver nanowires added in a polymer substrate for high thermo-conductivity.

To achieve the above purpose, the present disclosure is a silver-nanowire thermo-interface material composite, comprising a polymer substrate and a plurality of silver nanowires, where the silver nanowires are distributed in the polymer substrate; where the silver nanowires have a content more than 50 phr (33 wt %); and where each of the silver nanowires has a diameter of 40˜400 nanometers (nm) and a length of 5˜50 micrometers (μm). Accordingly, a novel silver-nanowire thermo-interface material composite is obtained.

### BRIEF DESCRIPTIONS OF THE DRAWINGS

The present disclosure will be better understood from the following detailed description of the preferred embodiment according to the present disclosure, taken in conjunction with the accompanying drawings, in which

FIG. 1 is the view showing the preferred embodiment according to the present disclosure; and

FIG. 2 is the view showing the formulations and thermo-conductivity coefficients.

### DESCRIPTION OF THE PREFERRED EMBODIMENT

The following description of the preferred embodiment is provided to understand the features and the structures of the present disclosure.

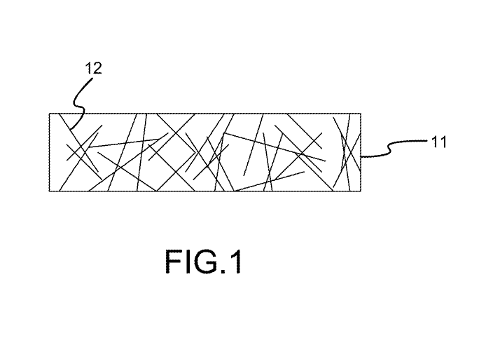

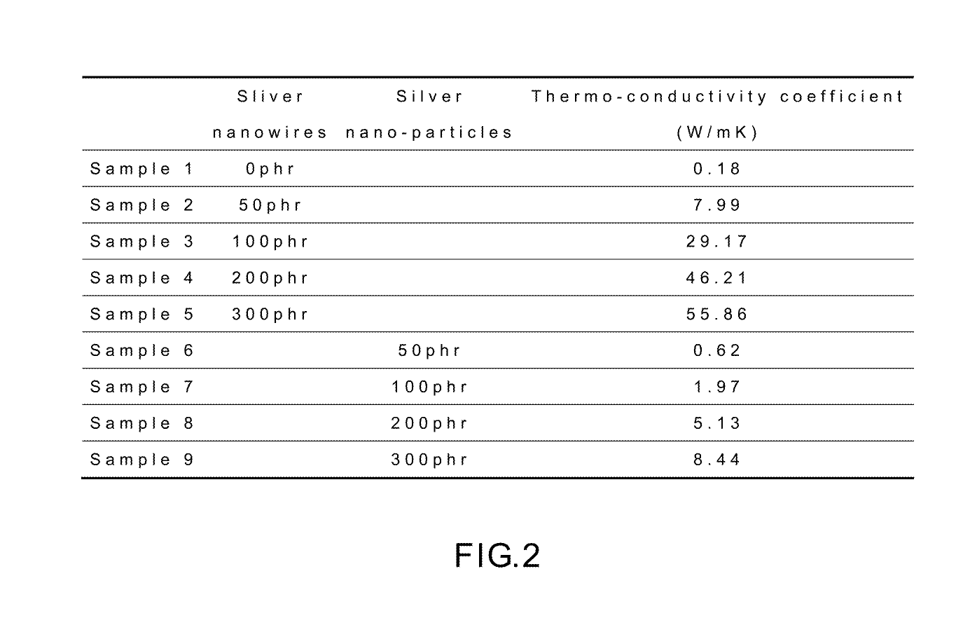

Please refer to FIG. 1 and FIG. 2, which are a view showing the preferred embodiment according to the present disclosure; and a view showing the formulations and thermo-conductivity coefficients. As shown in the figures, the present disclosure is a silver-nanowire thermo-interface material composite, comprising a polymer substrate 11; and a plurality of silver nanowires 12 evenly distributed in the polymer substrate 11.

The polymer substrate 11 is made of epoxy resin, vinyl ester resin, silicon oil, ethylene ethyl acetate, polyester, polyamide or polyimide; or a mixture of some of the above compounds.

Each of the silver nanowire 12 has a diameter of 40˜400 nanometers (nm) and a length of 5˜50 micrometers (μm).

The silver nanowire 12 has an aspect ratio higher than a silver particle. The silver nanowire 12 having the high aspect ratio acts like a bridge to form a thermo-channel under a low content for keeping characteristics of the thermo-interface material.

In a state of use, silver nanowires made according to the present disclosure have a 100 nm diameter and a 10 μm length for each, where the silver nanowires are obtained through pyrolysis, e.g. wet chemical synthesis, to be purified. A thermo-interface material is obtained through evenly distributing the silver nanowires in a polymer substrate to be hardened with epoxy resin; thus, the hardened polymer composite material containing cured silver nanowires inside is obtained.

Therein, the composite material of silver nanowires/epoxy resin is fabricated through the following steps:

(a) A hardener is blended with a small amount of acetone by a machinery blender for dispersal. Then, silver nanowires (or silver particles) are added for dispersal.

(b) Epoxy resin and the hardener are added into the solution with a mole formulation of 2:1, where silver nanowires (or silver particles) are added with a formulation of 50, 100, 200 or 300 phr (e.g. 50 phr means every 100 units of weight of epoxy resin uses 50 units of weight of silver nanowires or silver particles). Then, the mixture is strongly blended to obtain a homogeneous phase and then is added with a defoamer with blending continued until an even solution is obtained.

(c) Under a vacuum environment at 60 Celsius degrees (° C.), acetone in the mixture obtained in step (b) is removed. After no bubbles appear, the mixture is pasted to cover 400 μm thickness of a composite material of silver nanowires/epoxy resin on a copper foil surface, where bubbles are kept removing.

(d) A mould containing the mixture obtained in step (c) is put into an oven for a multi-stage elevation of temperature at 120° C., 160° C. and 180° C. each for 2 hours for crosslinking/hardening.

(e) At last, the hardened material is immersed in a copper etchant to remove the copper foil. After being washed with a deionized water and being hot-dried, a composite material of silver nanowires/epoxy resin having a high conductivity is obtained.

For measuring a thermo-conductivity coefficient of the thermo-interface material, a transient plane source method is used with Hot disk, TPS-2500, Sweden, where sensors are put between two samples to form a sandwich-like structure for measuring the thermo-conductivity coefficient. The shape of the sample is not specific but relatively flat surfaces are formed for being contacted with the sensors. The sample has a 3 millimeters (mm) thickness; the wattage applied in the measurement is 0.1 W; and, the time used in the measurement is 20 seconds (sec).

The composite material of silver nanowires/epoxy resin has a high thermo-conductivity coefficient of 55.86 W/mK, which is far higher than that of a general thermo-interface material (1 W/mK). With 100 phr of silver particles added in epoxy resin, a thermo-conductivity coefficient of 1.97 W/mK is obtained, which shows that the present disclosure can obtain the required thermo-conductivity coefficient for thermo-interface material. However, better thermo-conductivity characteristics can be obtained by adding silver nanowires. Take 50 phr of silver nanowires/epoxy resin as an example. The thermo-conductivity gain value is 43 times greater than that of a pure epoxy resin. It is mainly because that silver nanowires have higher aspect ratios than silver particles and are acted as bridges between silver nanowires, and, thus, a good thermo-conductive channel is formed with a low additive content.

To sum up, the present disclosure is a silver-nanowire thermo-interface material composite, where, through curing with at least a hardener, a thermo-interface material having a high thermo-conductivity coefficient is obtained with a polymer substrate and silver nanowires distributed in the polymer substrate; where the silver nanowires of the thermo-interface material have high aspect ratios, high high thermo-conductivity coefficients and good anti-oxidation capabilities and, thus, added amount of silver nanowires can be fewer than that of ceramic powder for dispersal process; and where surface defects of the thermo-interface material are spackled to further enhance adhesion between devices on forming a thermo-channel.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

1. A silver-nanowire thermo-interface material composite, comprising:
a polymer substrate comprising at least one of epoxy resin, vinyl ester resin, silicon oil, ethylene ethyl acetate, polyester, polyamide and polyimide;
a plurality of silver nanowires, said silver nanowires being evenly distributed in said polymer substrate; and
a copper foil wherein the polymer substrate and silver wire composite is formed on the copper foil.

2. (canceled)

3. The composite according to claim 1, wherein each of said silver nanowires has a diameter of 40˜400 nm and a length of 5˜50 μm.

4. The composite according to claim 1, wherein a content of said silver nanowires is higher than 50 phr.
